(19) United States
(12) Patent Application Publication
(10) Pub. No.: US 2025/0159505 A1
(43) Pub. Date: May 15, 2025

(54) METHODS AND APPARATUS FOR COORDINATED OPERATION OF USER EQUIPMENT (UE)

(71) Applicant: Huawei Technologies Co., Ltd., Shenzhen (CN)

(72) Inventors: Hua Xu, Ottawa (CA); Jianglei Ma, Ottawa (CA)

(21) Appl. No.: 19/022,630

(22) Filed: Jan. 15, 2025

Related U.S. Application Data
(63) Continuation of application No. PCT/CN2023/087441, filed on Apr. 11, 2023.
(60) Provisional application No. 63/390,846, filed on Jul. 20, 2022.

(51) Int. Cl. H04W 24/02; H04W 8/22; H04W 92/18

(52) U.S. Cl. CPC H04W 24/02; H04W 8/22; H04W 92/18

(57) ABSTRACT

For coordinated operation of UEs, operation of a UE is to be coordinated with an other UE for communicating with a network device in a wireless communication network. Signaling that indicates a limited-operation configuration is transmitted to and received by the UE, and the UE communicates according to the limited-operation configuration. The limited-operation configuration is for limited communication operations of the UE with the network device, and the limited communication operations are limited relative to a full-operation configuration of the other UE for communications with the network device.

### CROSS-REFERENCE TO RELATED APPLICATIONS

This application is a continuation of International Application No. PCT/CN2023/087441, filed on Apr. 11, 2023, which claims priority to U.S. Provisional Patent Application No. 63,390,846, titled “METHODS AND APPARATUS FOR COORDINATED OPERATION OF USER EQUIPMENT (UE),” filed Jul. 20, 2022. The disclosures of the aforementioned applications are hereby incorporated by reference in their entireties.

### TECHNICAL FIELD

The present application relates generally to wireless communications, and more specifically to coordinated operation of user equipment (UE).

### BACKGROUND

In conventional wireless communication systems, each UE within a cell or coverage area of a network device such as a base station typically transmits to and receives from the network device by itself. In this sense, such systems may be referred to as being cell-centric.

Direct UE-to-UE communication has been studied and specified in the form of device-to-device (D2D) communications, to improve communications between UEs. UE cooperation is targeted more toward a group of UEs working together to improve transmission to and/or reception from a base station, as well as between UEs. UE cooperation is therefore more UE-centric in design, and could complement features in a cell-centric system and improve overall system performance and capacity for downlink (DL) communications from base stations to UEs, uplink (UL) communications from UEs to base stations, and/or sidelink communications between an other UE to and from the UEs.

UE cooperation (UC) is currently a new subject in the 3rd generation partnership project (3GPP). Although some studies and specification focus on the sidelink (SL) based relay and UE aggregation, at present this is more a preliminary work from the UE cooperation perspective and requires further study. For example, the specific role of each UE in a group of UEs for UC, in terms of DL/UL transmission/reception operations and functions, has not been studied.

### SUMMARY

The present disclosure encompasses embodiments related to configuring respective transmission/reception operations, functions, or features for coordinated operation UEs, for UC for example. This may help improve overall coordinated operation capability, and also reduce the transmit/receive power and interference, as described in detail elsewhere herein.

Some embodiments may help simplify UE transmission and/or reception for coordinated operation. For example, different types of UE may be responsible for different tasks but can also support some common and essential tasks/functions.

Another potential benefit is reduced signaling overhead for UEs. With limited DL reception and/or UL transmission operation, signaling to one or more UEs could be reduced to thereby reduce signaling overhead.

Power savings to prolong UE battery life may also be realized. For example, only certain UEs may monitor/receive/transmit all primary signals or channels for coordinated operation. Other UEs may not need to monitor/receive/transmit all signal or channels, and thus can save power for other features such as data transmission boosting. The other UE(s) may also or instead support only certain functions and thereby lower their capability requirements for coordinated UE operation.

Any UEs that do not transmit all signals and channels, by not transmitting certain signals or channels, introduce less interference to other UEs relative to the level of interference that may be caused if all signal and channels were to be transmitted by all UEs.

UE DL/UL operational behaviors are clearly defined for coordinated operation in some embodiments, and this could save power, signaling overhead, or both, and yet not compromise the performance.

According to an aspect of the present disclosure, a method involves receiving, by a UE for which operation is to be coordinated with an other UE for communicating with a network device in a wireless communication network, signaling that indicates a limited-operation configuration for limited communication operations of the UE with the network device; and communicating, by the UE, with the network device according to the limited-operation configuration. The limited communication operations are limited relative to a full-operation configuration of the other UE for communications with the network device.

Another method involves transmitting, to a UE for which operation is to be coordinated with an other UE for communicating with a network device in a wireless communication network, signaling that indicates a limited-operation configuration; and communicating with the UE according to the limited-operation configuration. The limited-operation configuration is for limited communication operations of the UE with the network device, and the limited communication operations are limited relative to a full-operation configuration of the other UE for communications with the network device.

In apparatus embodiments, an apparatus may include a processor and a non-transitory computer readable storage medium that is coupled to the processor. The non-transitory computer readable storage medium stores programming for execution by the processor. The apparatus may be, in various embodiments, a UE, a network device, one or more components in a UE, one or more components in a network device, a chipset in a UE, or a chipset in a network device, for example.

A storage medium need not necessarily or only be implemented in or in conjunction with such an apparatus. A computer program product, for example, may be or include a non-transitory computer readable medium storing programming for execution by a processor.

Programming stored by a computer readable storage medium may include instructions to, or to cause a processor to, perform, implement, support, or enable any of the methods disclosed herein.

For example, the programming may include instructions to, or to cause a processor to: receive, by a UE for which operation is to be coordinated with an other UE for communicating with a network device in a wireless communication network, signaling that indicates a limited-operation configuration; and communicate, by the UE, with the network device according to the limited-operation configuration.

In another embodiment, programming includes instructions to, or to cause a processor to: transmit, to a UE for which operation is to be coordinated with an other UE for communicating with a network device in a wireless communication network, signaling that indicates a limited-operation configuration; and communicate with the UE according to the limited-operation configuration.

According to another aspect of the present disclosure, a communication system is provided, wherein the communication system comprises the network device and at least one the UE and at least one the other UE.

In these embodiments, as in other embodiments, the limited-operation configuration is for limited communication operations of the UE with the network device, and the limited communication operations are limited relative to a full-operation configuration of the other UE for communications with the network device.

The present disclosure encompasses these and other aspects or embodiments.

### BRIEF DESCRIPTION OF THE DRAWINGS

For a more complete understanding of the present embodiments, and the advantages thereof, reference is now made, by way of example, to the following descriptions taken in conjunction with the accompanying drawings.

FIG. 1 is a simplified schematic illustration of a communication system.

FIG. 2 is a block diagram illustration of the example communication system in FIG. 1.

FIG. 3 illustrates an example electronic device and examples of base stations.

FIG. 4 illustrates units or modules in a device.

FIG. 5 is a block diagram of an example communication system illustrating multiple communication paths or links.

FIG. 6 is a block diagram of the example communication system in FIG. 5, illustrating different UE configurations for DL reception according to an embodiment.

FIG. 7 is a block diagram of the example communication system in FIG. 5, illustrating different UE configurations for UL transmission according to an embodiment.

FIG. 8 is a block diagram of the example communication system in FIG. 5, illustrating different UE configurations for DL reception and UL transmission according to an embodiment.

FIG. 9 is a signal flow diagram illustrating an example of signaling and coordinated operation of UEs according to an embodiment.

FIG. 10 is a signal flow diagram illustrating an example of signaling and coordinated operation of UEs according to another embodiment.

FIG. 11 is a block diagram illustrating an example of a telecommunications network according to one embodiment.

FIG. 12 is a block diagram illustrating an example of a network serving two UEs.

### DETAILED DESCRIPTION

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

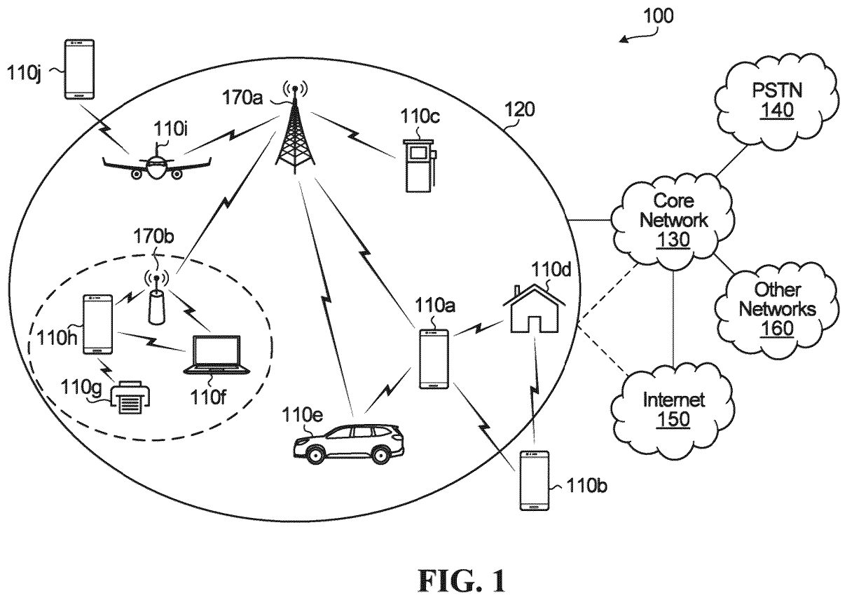

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

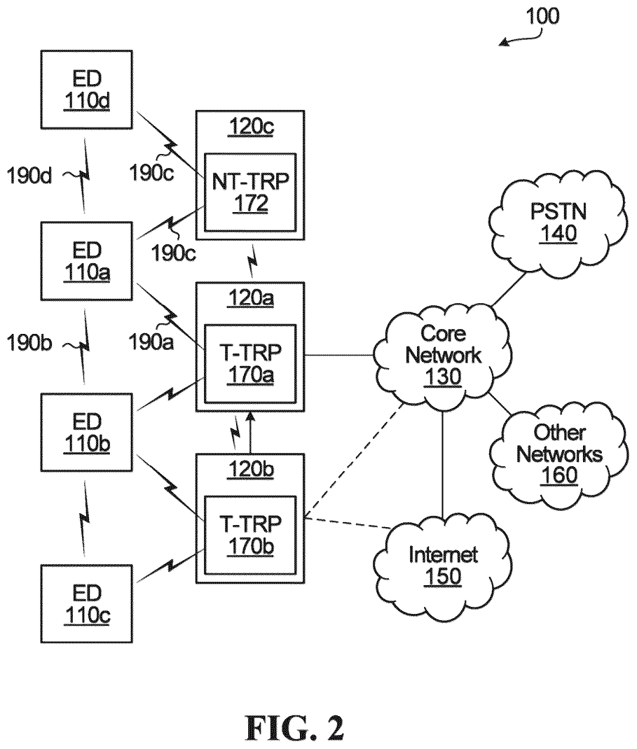

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

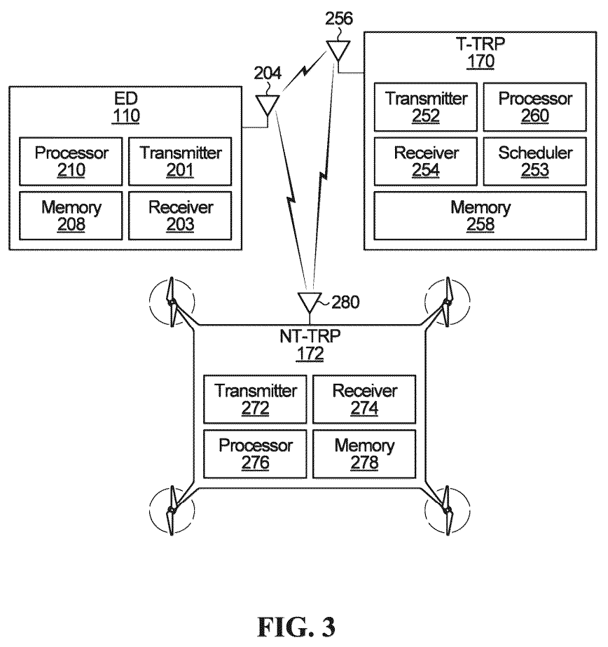

FIG. 3 illustrates another example of an ED no and a base station 170a, 170b and/or 170c. The ED no is used to connect persons, objects, machines, etc. The ED no may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED no represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

The T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output (MIMO) precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

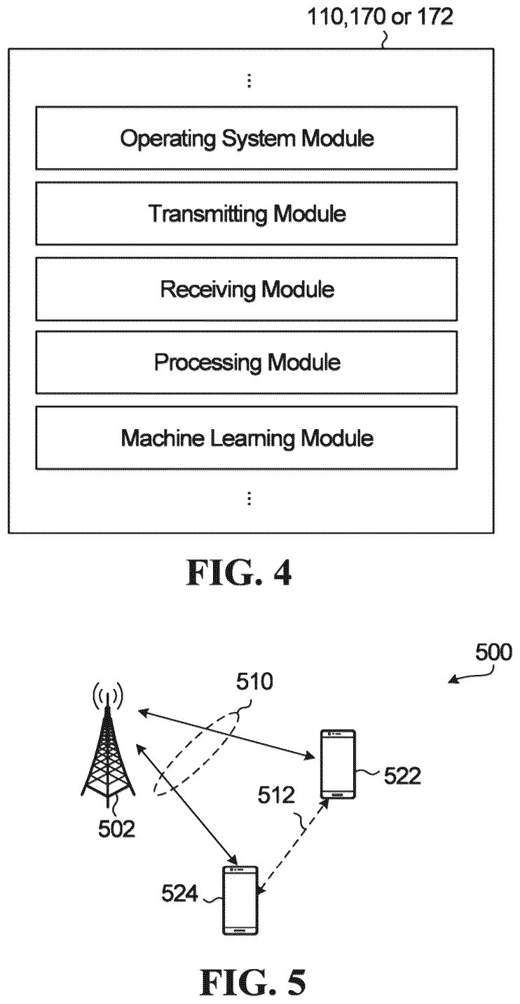

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 11o, the T-TRP 170 and the NT-TRP 172 are known to those of skill in the art. As such, these details are omitted here.

Having considered communications more generally above, attention will now turn to particular example embodiments.

Some embodiments disclosed herein relate to configuring UEs, for which coordinated operation is to be enabled, supported, or implemented, with UL transmission and/or DL reception operations, functions, or features that are different from those that are configured for normal “stand-alone” operation of each UE individually. In a cell-centric wireless communication network, for example, UEs that are intended to operate individually, on their own, in communicating with a network device such as a base station, may be configured in a similar manner and support the same or very similar operations or features. For coordinated operation, however, UEs may be configured differently.

As used herein, coordinated operation of UEs is intended to encompass cooperative operation between UEs such as UC, but is not limited only to UC. UEs that are configured for coordinated operation with each other may be part of a UC group or participate in UC, but embodiments herein are not in any way limited to coordinated operation that is specifically referred to as UC. Coordinated operation may include UC, but is not limited to UC. In other words, UC may be an example of coordinated operation, but coordinated operation may also or instead be implemented or supported in other ways that may not necessarily be referred to as UC.

According to embodiments, transmission and/or reception may be configured differently for different UEs. Each UE for which operation is to be coordinated with another UE is configured differently for coordinated operation, so that its behavior is different for coordinated operation than for individual operation when it is operating on its own for communications with a network device. Operation of a UE without coordination with an other UE may be referred to, for example, as individual UE operation, normal operation, or non-coordinated operation.

For coordinated operation, different UEs may be configured with different operations, features, or functions for transmission and/or reception. Configurations may vary between UEs based on the type or role of each UE in coordinated operation. Configurations may also or instead vary depending on different applications, such as whether UE operation is to be coordinated for a UL data boosting application or a DL data boosting application.

Configuration for coordinated operation of UEs may be semi-static or dynamically signaled, or explicitly or implicitly indicated.

Embodiments for configuring UEs for coordinated operation include embodiments in which one or more UEs are configured by a network device such as a gNB, and/or a UE such as a primary UE is involved in configuring one or more other UEs.

These and other embodiments are described in detail herein.

FIG. 5 is a block diagram of an example communication system illustrating multiple communication paths or links. The example system 500 includes a network device 502, and UEs 522, 524, for which coordinated operation is to be configured. Communications between the UEs 522, 524 and the network equipment 502 are through direct communication paths or links shown by way of example as Uu links 510 in FIG. 5, and a UE-to-UE communication link (or inter-UE connection or link) between the UEs is shown at 512. The UE-to-UE communication link may be, but is not limited to, a sidelink for example. Examples and implementation options for network devices, UEs, and links are provided elsewhere herein. The network device 502 may be a network device or equipment such as a network node 170a, 170b in FIGS. 1 and 2 or 170 in FIGS. 3 and 4 or an access node 172 in FIGS. 2 to 4, and the UEs may be EDs 110a-c in FIGS. 1 and 2 or 110 in FIGS. 3 and 4, for example. As one application of UE coordination, in UC operation, the UEs 522 and 524 could work together to help with transmission and/or reception for one of the UE, for example, UE 522, which could be referred as a source UE (SUE, for uplink transmission) or a target UE (TUE, for downlink reception). For uplink UC, one portion of data from the SUE could be transmitted directly to the network device 502 via Uu link 510, and the same or another portion of the data from the SUE could be transmitted indirectly to the network device 502 via another UE 524 (first via UE-to-UE link 512 to the UE 524, then relayed by the UE 524 via Uu link 510). For downlink UC, data destined to the TUE could be transmitted directly from the network device 502 via Uu link 510 to the TUE (522), while it (or another portion of the data) could be transmitted indirectly from the network device 502 to the TUE via another UE 524 (first via Uu link 510 to the UE 524, then relayed by the UE 524 via UE-UE link 512).

FIG. 5 represents a scenario in which both of the UEs 522, 524 are “in-coverage” (within a geographical area of direct communication with the network device 502). There is a Uu path or link between the network device 502 and each UE 522, 524 in the example shown. The UEs are also connected to each other by the UE-to-UE connection 512.

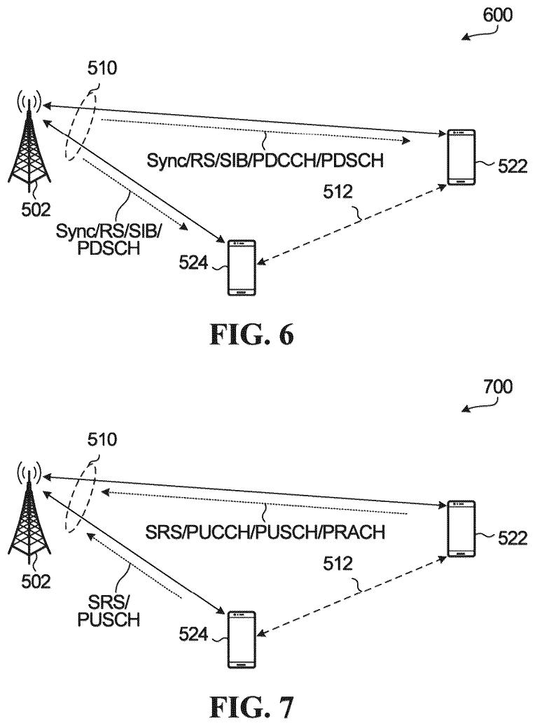

When operation of two or more UEs is to be coordinated, such as when the UEs are participating in UC for transmission and/or reception, each UE may be configured differently. The different configurations may relate to DL reception, UL transmission, or both. This is shown by way of example in FIGS. 6 and 7. FIG. 6 is a block diagram of the example communication system in FIG. 5, illustrating different UE configurations for DL reception according to an embodiment, and FIG. 7 is a block diagram of the example communication system in FIG. 5, illustrating different UE configurations for UL transmission according to an embodiment.

Optionally, the different configurations may affect or apply to sidelink or other inter-UE transmission/reception. For example, with reference to FIG. 6, the UE 522 may receive and decode control information from PDCCH and transmit corresponding information to the UE 524, whereas the UE 524 does not receive PDCCH in the example shown. Similarly, with reference to FIG. 7, the UE 524 may transmit some control information to the UE 522 for transmission on PUCCH by UE 522, because the UE 524 itself does not transmit PUCCH.

In a coordinated operation embodiment, a UE that may be considered a first type of UE or a UE that is to operate in a first role for coordinated operation, could be configured to transmit and/or receive all types of control and traffic signals or channels in UL and/or DL, in addition to signals or channels as they normally do for individual UE operation. A first type of UE may be referred to, for example, as a primary UE for coordinated operation, and may be a source UE (SUE) for UL transmission, a target UE (TUE) for DL reception, or a cooperative UE (CUE) such as a relay UE in an indirect path or link between an SUE or TUE and a network device. In FIGS. 6 and 7, for example, the UE 522 is a first type of UE.

For DL reception in FIG. 6, the UE 522 may be configured to monitor and/or receive the following signals and channels, for example:
a sync signal (synchronization signal block (SSB), for example): for synchronizing to the communication network;
a reference signal (RS), such as channel state information reference signal (CSI-RS), tracking reference signal (TRS), or cell specific reference signal (CRS): for UL/DL short term or long term channel measurement, carrier frequency offset adjustment, etc.;
system information block (SIB): system information;
paging information: for waking up sleeping UEs;
physical downlink control channel (PDCCH): DL control channel (for UL and DL scheduling, etc.);
physical downlink shared channel (PDSCH): DL data channel, which may include corresponding demodulation reference signal (DMRS), for example.

For UL transmission in FIG. 7, the UE 522 may be configured to transmit the following signals and channels, for example:
sounding reference signal (SRS): for UL/DL channel measurement;
physical uplink control channel (PUCCH): UL control channel to carry uplink control information (UCI), which may include channel state information (CSI), hybrid automatic repeat request acknowledgement (HARQ-ACQ), scheduling request (SR), etc.;
physical uplink control channel (PUSCH): UL data channel, which may carry UCI, and may include corresponding DMRS, for example;
physical random access channel (PRACH): for random access and UL synchronization and time alignment.

The signals and channels referenced above and in FIGS. 6 and 7 are examples only, to illustrate what may be referred to as a full-function, full-feature, or full-operation reception or transmission configuration according to embodiments.

Coordinated operation embodiments also involve one or more UEs that may be considered a second type of UE or a UE that is to operate in a second role for coordinated operation. A UE of the second type could be configured to transmit and/or receive only a limited subset of signals or channels in UL and/or DL, such as only essential signals that are required for coordinated operation, and optionally other limited signals or channels in UL and/or DL. The signals or channels that a second type of UE is configured to transmit or receive do not include all signals or channels that are transmitted or received for individual UE operation, and also do not include all signals or channels that a first type of UE is configured to transmit or receive. A configuration for the second type of UE may be referred to as a limited-function, limited-feature, or limited-operation transmission or reception configuration.

A UE of the second type may be referred to, for example, as a secondary UE for coordinated operation, and may be a source UE (SUE) for UL transmission, a target UE (TUE) for DL reception, or a cooperative UE (CUE) such as a relay UE in an indirect path or link between an SUE or TUE and a network device. In FIGS. 6 and 7, for example, the UE 524 is a UE of the second type.

For DL reception in FIG. 6, the UE 524 may be configured to monitor or receive the following signals and channels, for example:
a sync signal (SSB, for example);
an RS, such as CSI-RS, TRS, or CRS;
SIB;
PDSCH.

In the example shown in FIG. 6, the UE 522 is a first type of UE and is configured for reception of PDCCH and paging information, whereas the UE 524 is a second type of UE and is not configured for reception of PDCCH and paging information.

In other embodiments, there may be other signals or channels that are part of a configuration for a first type of UE but not a configuration for a second type of UE. For example, a UE of the second type might not be configured to receive synchronization signals and/or SIB directly from a network device, and may be configured to instead obtain corresponding information from a UE of the first type. For example, if a UE is not configured to receive a sync or SIB signal, it may obtain such information from a UE of the first type via an inter-UE path, link, or connection as shown by 512, also referred to herein as a UE-to-UE path, link, or connection. In another example, a UE of the second type could be configured in a sleeping mode such as a discontinuous reception (DRX) mode if there is no data to receive or transmit, and could be woken up from the sleeping mode by a UE of the first type, to receive in DL or transmit in UL in a coordinated manner with the UE of the first type. A wake-up signal could be conveyed between UEs via the inter-UE connection 512.

For UL transmission in FIG. 7, the UE 524 may be configured to transmit the following signals and channels, for example:
SRS;
PUSCH.

In this example, uplink transmission of PUCCH and PRACH are part of the configuration for the UE 522, but not the UE 524.

The signals and channels referenced above and in FIGS. 6 and 7 for a UE of the second type are examples only, to illustrate a transmission or reception configuration according to embodiments. In general, different UEs could be configured to support different types of signals and channels for coordinated operation.

It is also noted that the first type of UE may transmit/receive parts of the above listed channels/signals or may include other channels/signals. The point is that channels/signals transmitted/received by the second type of the UE are still a subset of the channels/signals transmitted/received by the first type of UE.

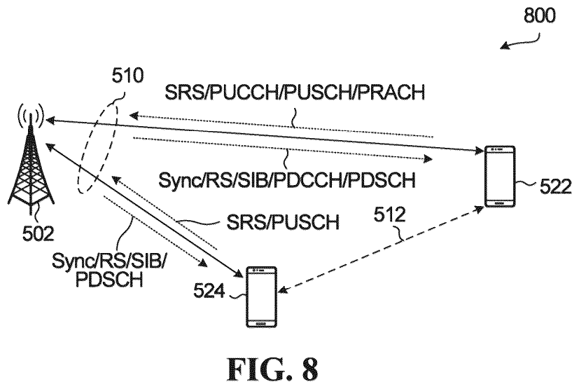

DL reception and UL transmission configurations are not mutually exclusive. A UE may be configured for DL reception, UL transmission, or both. FIG. 8 is a block diagram of the example communication system in FIG. 5, illustrating different UE configurations for DL reception and UL transmission according to an embodiment. The example 600 in FIG. 6 illustrates DL reception configurations, the example 700 in FIG. 7 illustrates UL transmission configuration, and the example 800 in FIG. 8 illustrates UE configurations for both DL reception and UL transmission. In the example 800, each UE 522, 524 is configured for both DL reception and UL transmission.

Other embodiments are also possible. For example, a UE that is configured as a first type of UE for coordinated operation with a second type of UE for DL reception may itself be configured as a second type of UE for coordinated operation with another UE for UL transmission. A UE may be configured as a first type of UE for coordinated operation with multiple UEs of the second type, for DL reception and/or UL transmission. Further variations of coordinated operation may be or become apparent based on the present disclosure.

Configurations related to coordinated operation of UEs may be explicitly or implicitly signaled, or assumed by default. Signaling to indicate UE configurations or other information to indicate whether a UE is to operate or behave as a first type of UE or a second type of UE may be or include semi-static signaling or dynamic signaling. For example, higher layer signaling such as radio resource control (RRC) signaling may be used to indicate such a configuration explicitly. A configuration may configure each UE for respective UL/DL transmit/receive operations, features, or functions using an identifier of each UE, such as a radio network temporary identifier (RNTI) or a local or group-specific identifier of a UE in a group of UEs between which operation is to be coordinated. Identifier-based configurations are expected to involve semi-static signaling, but other embodiments may involve different types of signaling.

A configuration such as a number of antennas could be used to implicitly indicate corresponding UL/DL transmission/reception operations, features, or functions. For example, suppose that operation of two UEs, each having 2T2R (two transmit antennas and two receive antennas), is to be coordinated for UL transmission. The UEs may be configured with a 4T/2R configuration to indicate that only one UE (e.g., a primary UE) is configured implicitly for major signals or channels for full operation (PDCCH/PDSCH) reception in DL. However, in UL, both UEs are configured to transmit SRS/PUSCH with total 4 transmit antennas. Similarly, a 2T/4R configuration may be used to implicitly signal coordinated operation for DL reception with both UEs to receive on DL but only one UE is to transmit in UL, and a 4T/4R configuration may be used to implicitly signal coordinated operation for both UL transmission and DL reception.

Further, antenna port could be used to indicate which UE is selected to transmit or receive. For example, supposed that the two UEs 522, 524 in FIG. 6 each have 2T2R, and their antenna ports are allocated as: port {0,1} for UE 522, and port {2,3} for UE 524 for 4T/2R coordinated operation. In this example, configuring ports {0,1} as receive antennas indicates that UE 522 is selected for DL reception of PDCCH/PDSCH. Thus, UE 522 in this example monitors and receives PDCCH/PDSCH in DL.

There need not necessarily be explicit signaling of respective configurations, and different types of UE could be assumed by default to support corresponding transmission and/or reception operations, features, or functions. For example, a primary UE may by default be responsible transmission or reception of all UL or DL signals or channels such as PDCCH/PDSCH or PUCCH/PUSCH, whereas a secondary UE is responsible for transmission or reception of only UL or DL signals or channels that are related to data traffic, such as SRS and PUSCH or PDSCH. In this example, UL transmission/DL reception configuration is inherent or implicit in configuring a UE as a primary UE or a secondary UE. In this sense, signaling to configure or designate a UE as a primary UE or a secondary UE is another example of signaling that indicates (implicitly) UL transmission/DL reception configuration.

Dynamic signaling such as that carried by downlink control information (DCI) could be used to indicate DL reception/UL transmission operation, features, or functions. For example, dynamic indication can be used to indicate or trigger respective transmit and/or receive operations, features, or functions.

Semi-static and dynamic signaling could be used together. For example, semi-static signaling could be used to configure UEs with respective UL transmission and/or DL reception configurations in a more semi-static manner, and dynamic signaling could be used to dynamically overwrite or trigger some or all of the configured operations, features, or function according to whether a UE is to operate as a first type of UE or a second type of UE for coordinated operation.

UE configurations may be network-managed and handled by a network device such as a gNB or base station, or a UE such as a primary UE may be involved in configuring one or more other UEs for coordinated operation.

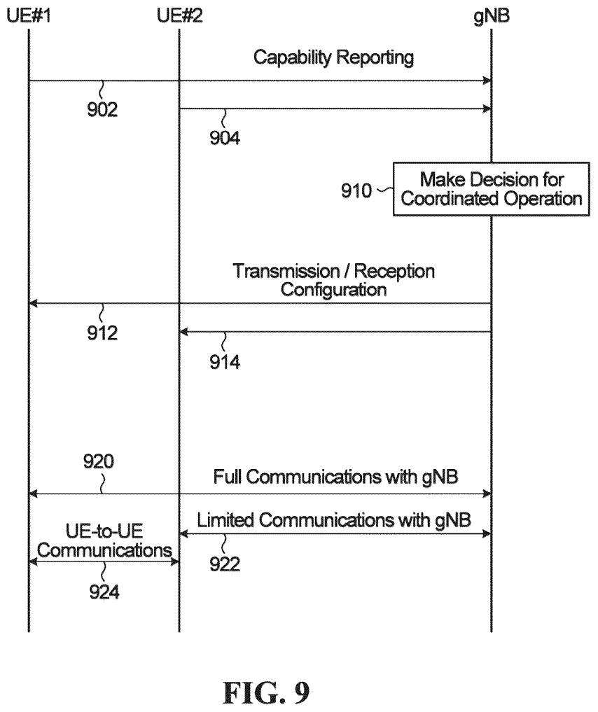

FIG. 9 is a signal flow diagram illustrating an example of signaling and coordinated operation of UEs according to an embodiment. The example shown in FIG. 9 relates to a network-managed embodiment that involves two UEs, shown as UE #1 and UE #2, and a gNB as an example of a network device.

As shown in FIG. 9, each UE may report its respective capability for coordinated operation to the gNB. Signaling indicative of coordinated operation capability is shown at 902, 904. Thus, some embodiments involve transmitting, by a UE to a network device such as the gNB, signaling indicative of the capability of each UE for coordinated operation with another UE. Network-side operations may involve receiving such signaling, from one or more UEs. Capability reporting may be initiated or triggered by each UE, or in response to a request or other signaling (not shown) from the gNB.

Individual UE capabilities may include one or more parameters, properties, features, or functions, such as any one or more of the following illustrative examples: number of antennas, MIMO capability, and SL protocol or capability. SL protocol or capability may include, for example, any one or more of: Bluetooth™, WiFi, NR sidelink, and bandwidth support. UE capability for coordinated operation, reported at 902, 904, may include, for example, any one or more of: information on a cross-link between UEs such as protocol used (WiFi, Bluetooth, sidelink), frequency and bandwidth, latency, etc.; antenna ports; power; and maximum number of MIMO layers.

A capability for coordinated operation may or may not be the same as individual UE capability, or in other words the capability of a UE to provide or support coordinate operation with another UE, may be different from the capability of the UE when the UE operates on its own. For example, a UE that has 4 antennas may report 2 antennas as part of its capability for UE coordinated operation or capability of transmission/reception of a subset of signals/channels for UE coordinated operations. Thus, a UE may report only some of its capabilities for coordinated operation with one or more other UEs.

As shown at 910, the gNB makes a decision as to whether coordinated operation between the UEs is to be configured, and signaling that indicates respective transmission/reception configurations for the UEs are transmitted to the UEs at 912, 914.

Thus, after the gNB receives capability report signaling from the UEs at 902, 904 in the example shown, and in some embodiments in response to receiving such signaling, a determination is made by the gNB at 910 as to whether coordinated operation between the UEs is to be configured. More generally, in some embodiments a network device may make a decision as to whether to coordinate operation between two or more UEs. Any of various criteria may be used to determine whether coordinated operation between UEs is to be configured. A decision or determination may be made, for example, based on the capability reporting and any one or more of: at least a certain number of UEs being available for coordinated operation, such as they have no (or below a threshold amount of) traffic to transmit at the moment; they belong to the same user or same entity (owner, company, office etc.); and at least a certain amount of added capability being available for coordinated operation, such as at least a certain number of additional antennas or transmit power or processing capability. One or more other criteria may also or instead be used. Other examples of criteria that may be used in a coordinated operation determination include: the UEs between which operation is to be coordinated having good channel quality to a network device such as a gNB, the UEs having good channel quality (or cross-link) among themselves, or the UEs moving together.

In the event of a positive determination, the gNB transmits, and each UE receives, signaling that indicates a respective configuration for the UE. A configuration could indicate or include, for example, any one or more of the following:
a UE identifier such as an RNTI for each UE;
traffic direction(s) for coordinated operation, such as UL only, DL only, or both UL and DL;
identification of one or more of the UEs for coordinated operation, such as an SUE for UL or a TUE for DL, CUE(s), primary UE(s), secondary UE(s), UE(s) of first type, UE(s) of second type;
one or more parameters of a UE-to-UE link, which may be a dedicated link between UEs, such as protocol, latency, data rate, carrier frequency, bandwidth, data error rate, modulation, etc.

These are examples only, and other information may also or instead be included in UE transmission/reception configurations.

In general, different transmission and/or reception operations could be configured, such as for different modes. UEs of a first type and UEs of a second type operate differently as disclosed herein. There may also be other different modes of operation. For example, for a power saving mode, limited transmission and/or reception operations or function could be configured to save UE power. Such features may be configured in addition to different communication operations for the purpose of coordinated operation. A UE of the first type and/or a UE of the second type may potentially be configured for a power saving mode. Thus, implementation of coordinated operation between UEs as disclosed herein does not necessarily preclude or otherwise impact other features or modes of operation.

UL/DL transmit/receive operations for different types of UEs or UEs that have different roles for coordinated operation may involve transmitting and/or receiving different channels or signaling. In other embodiments, communication operations for UL transmission and/or DL reception may involve configuring operations or features such as any one or more the following differently for different UEs between which operation is coordinated:
Carrier aggregation (CA): For example, some UE(s) may be configured with CA, whereas others are not;
Dual-connectivity (DC): For example, some UE(s) may be configured with DC, whereas others are not;
Handover (HO): For example, some UE(s) may be configured with HO, whereas other are not, and coordinated UEs could HO together.

These and/or other features may be configured for different UEs based on UE type(s) or role(s) for coordinated operation, or, as described at least above for power saving mode, may be configured in addition to different communication operations for the purpose of coordinated operation.

Respective UE configurations for DL reception and/or UL transmission as disclosed herein may simplify operation of one or more UEs. DL/UL transmission/reception operations or functions can be configured separately, depending on how operation between UEs is to be coordinated. For example, one or more UEs, also referred to herein as UEs of a second type, could be configured with only limited DL reception operations or functions and/or only limited UL transmission operation or functions, whereas one or more other UEs, also referred to herein as UEs of a first type, may be configured for full-featured or full-operation communications.

In the example shown in FIG. 9 each UE receives signaling that indicates a configuration, at 912, 914. UE #1 has a full-operation configuration and UE #2 has a limited-operation configuration in the example shown. At 920, FIG. 9 illustrates the UE #1 engaging in “full” communications with the gNB, and this is intended to indicate transmission and/or reception of all necessary channels or signals that a UE transmits or receives during normal operation. Examples are shown in FIGS. 6 to 8 for the UE 522. Limited communication operations between UE #2 and the gNB are illustrated in FIG. 9 at 922. UE-to-UE communications at 924 enable communication information such as control information to be exchanged between the UEs, due to the limited-operation configuration of UE #2 in this example. Coordinated communications between the UEs and the gNB in the example shown involve what is referred to herein as full communication operations between the UE #1 and the gNB at 1020, what is referred to herein as limited communication operations between the UE #2 and the gNB at 1022, and UE-to-UE communications, also referred to herein as inter-UE communications, between the UEs at 1024.

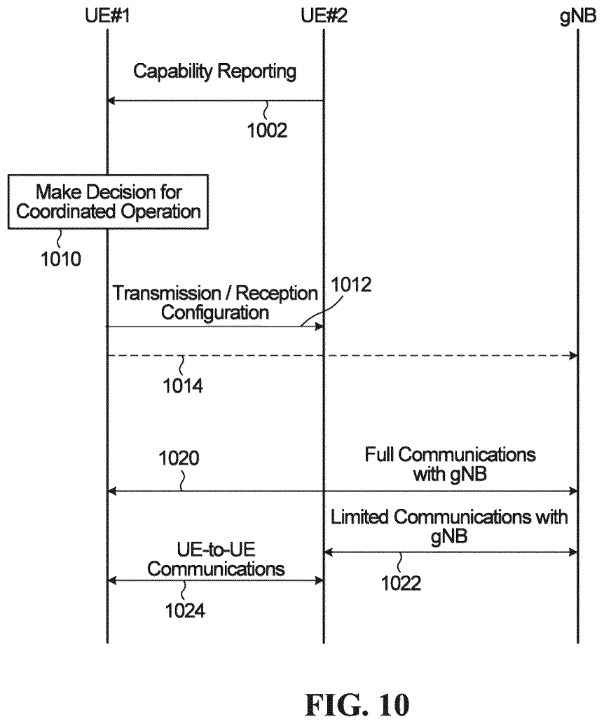

FIG. 10 is a signal flow diagram illustrating an example of signaling and coordinated operation of UEs according to another embodiment. The example shown in FIG. 10 is substantially similar to the example in FIG. 9, except that in FIG. 10 it is a UE, and in particular UE #1 in this example, that makes the coordinated operation decision or determination at 1010.

In FIG. 10, UE #1 is a primary UE for coordinated operation. UE #2 may report its capability for coordinated operation to UE #1, in signaling as shown at 1002, and UE #1 determines at 1010 whether coordinated operation is to be configured. Examples of decision or determination criteria are provided at least above with reference to FIG. 9. Responsive to, or otherwise based on a positive determination, signaling indicative of a configuration is transmitted to, and received by, UE #2 at 1012. UE #1 could also report such configuration to the gNB as shown at 1014, or instead not report the configuration to the gNB and thus make the role of each UE for coordinated operation transparent to the gNB.

Other features shown in FIG. 10 at 1020, 1022, 1024 may be substantially the same as similarly-labelled features in FIG. 9.

Features discussed above with reference to FIG. 9 may also or instead be implemented in embodiments that are consistent with FIG. 10.

The examples in FIGS. 9 and 10 are intended to be illustrative and not limiting. Other embodiments may include additional, fewer, and/or different features, implemented in similar or different way or orders than shown or described.

For example, although not shown in FIGS. 9 and 10, some embodiments may involve enabling or triggering communication operations according to UE configurations. Signaling to enable or trigger signaling could be used to enable or trigger transmission and/or reception operations or functions, or more generally to enable or trigger coordinated operation between UEs. For example, DL reception/UL transmission configured at 912, 914, 1012 could be triggered or enabled by an indication carried in DCI (or SCI in the example shown in FIG. 10), or by an activation indication similar to carrier aggregation (CA) activation, in a MAC control element (MAC-CE).

UE behaviors or features for coordinated operation are shown generally and by way of example in FIGS. 9 and 10. Considering the first type of UE disclosed herein, which is UE #1 in FIGS. 9 and 10, for DL, such UEs could be configured to monitor/receive all major signals or channels from the network and pass received signals or information to one or more UEs of the second type that are not configured to monitor or receive such signals or channels.

For example, some embodiments may involve decoding, by a UE of the first type (also referred to herein as a first type UE for ease of reference), DCI received in PDCCH (such as any of: scheduling information, transmit power control (TPC) command), and sending corresponding information to one or more UEs of the second type (also referred to herein as a second type UE for ease of reference). Scheduling information corresponding to scheduling information decoded from DCI may be transmitted (e.g., via SCI) by a first type UE to a second type UE so that the second type UE can receive data on PDSCH from the network and transmit data on PUSCH to the network. A first type UE could also or instead pass a UL power control command or information to a second type UE from decoding TPC.

Another example of first type UE behavior is sending a wake-up signal to one or more second type UEs after receiving paging from a gNB or other network device.

A first type UE may also or instead be responsible for collecting information from second type UE(s) and pass that information to a network device. Such information may include, for example, any of: DL channel state information (CSI), and UCI for DL transmission including HARQ-ACK feedback and/or SR in some embodiments.

Such information exchange between UEs, also referred to herein as exchanging communication information, could be accomplished via inter-UE connections between first and second types of UEs.

For UL, a first type UE may be configured to transmit all major signals or channels. First type UEs may also or instead be responsible for synchronizing with one or more second type UEs and/or informing the second type UE(s) of corresponding timing advance (TA) information via inter-UE connection(s). First type UE behavior or features may also or instead include sending a wake-up signal to one or more second type UEs via inter-UE connection(s) when the first type UE has UL data that is to be transmitted to a network device by both the first type UE and the second type UE(s) in a coordinated manner. Another example of a first type UE behavior or feature that may be provided in some embodiments is that a first type UE could be responsible for collecting information from one or more second type UEs such as HARQ-ACK/SR/DL CSI via inter-UE connection(s) as also described above, and transmit such information as UCI in PUCCH, for example, for the second type UE(s).

For example, some embodiments may involve decoding, by a UE of the first type, DCI received in PDCCH (such as any of: scheduling information, transmit power control (TPC) command), and sending corresponding information to one or more UEs of the second type. Scheduling information corresponding to scheduling information decoded from DCI may be transmitted (e.g., via SCI) by a first type UE to a second type UE so that the second type UE can receive data on PDSCH from the network and transmit the data on PUSCH to the network.

Second type UEs operate or behave differently from first type UEs according to embodiments disclosed herein.

For DL, a second type UE could be configured to monitor/receive limited signals or channels directly from a network device, and receive other signals or channels, or information carried in or on those signals or channels, from first type UEs. For example, a second type UE may receive information (e.g. via SCI) corresponding to DCI decoded from PDCCH by a first type UE. Such information may correspond to scheduling information and/or TPC commands decoded from DCI, for example.

A second type UE may also or instead be configured to receive a wake-up signal from a first type UE if the second type UE is in sleeping mode.

In some embodiments, second type UEs are configured to pass information to first type UEs, the following examples of which are provided at least above: DL CSI, and UCI for DL transmission.

Information could be exchanged between UEs via an inter-UE connection between a first type UE and a second type UE.

Different UE behaviors or features may also or instead be related to other aspects of DL operations. For example, second type UEs could be configured to skip (that is, not to perform) at least some DL measurements, such as reference signal received power (RSRP), reference signal received quality (RSRQ), and/or others. If a second type UE is close to a first type of UE, then such measurements by the second type UE may not be needed.

For UL, a second type UE could be configured to transmit limited signals or channels, relative to the signals or channels that a first type UE is configured to transmit.

A second type UE may also or instead be configured to receive UL sync information such as TA from a first type UE via an inter-UE connection, and adjust time alignment for its UL transmission accordingly.

Another possible UL operation or feature for a second type UE is receiving a wake-up signal from a first type UE via an inter-UE connection, to get ready for transmitting data in UL, in a coordinated manner with the first type UE.

A second type UE may also or instead be configured to pass information to a first type UE, such as HARQ-ACK/SR/DL CSI via an inter-UE connection, to be transmitted to a network device by the first type UE, as UCI in PUCCH for example.

In FIGS. 9 and 10, first type UE behaviors in respect of communications with a network device are illustrated by way of example at 920, 1020, where “Full” is intended to generally represent more complete communication operations with a network device. This is described at least above as transmitting and/or receiving all major signals or channels. Examples of such signals and channels are described elsewhere herein, and some examples are shown in FIGS. 6 to 8. Similarly, second type UE behaviors in respect of communications with a network device are illustrated byway of example at 922, 1022, where “Limited” is intended to generally represent limited communication operations with a network device, relative to communication operations of first type UEs. Second type UEs may transmit or receive only a subset or some of the signals or channels that first type UEs are configured to transmit or receive. Examples of such signals and channels are also described elsewhere herein, and some examples are shown in FIGS. 6 to 8. UE-to-UE communications at 924, 1024 are intended to generally represent exchanging communication information between first and second type UEs, due to limited-operation configuration of second type UEs for communications with a network device.

FIGS. 9 and 10 are illustrative of various embodiments. More generally, a method consistent with the present disclosure may involve receiving, by a UE for which operation is to be coordinated with an other UE for communicating with a network device in a wireless communication network, signaling that indicates a limited-operation configuration. Receiving such signaling by a UE is shown by way of example for the UE #2 at 914, 1012 in FIGS. 9 and 10. The UE for which operation is to be coordinated with the other UE for communicating with the network device may be an SUE or a TUE that is to be assisted by the other (first type) UE for communicating with the network device, or may be a CUE that is to assist the other UE (first type of UE which may be an SUE or TUE), for example.

The limited-operation configuration is for limited communication operations of the UE with the network device. The limited communication operations are limited relative to a full-operation configuration of the other UE for communications with the network device. The UE referenced in this example is a second type of UE, and the other UE referenced in this example is a first type of UE.

The UE and the other UE have different roles in coordinated operation, and operate differently. For instance, this example method may involve communicating, by the UE, with the network device according to the limited-operation configuration. Put another way, a method may involve the UE and the other UE communicating with the network device in a coordinated way, with the UE communicating with limited operation and the other UE communicating with full operation. Limited and full communication operations with a network device, and inter-UE communications that may also be involved in coordinated communications, are illustrated 920, 922, 924, respectively, in FIG. 9 and at 1020, 1022, 1024, respectively, in FIG. 10.

Embodiments may also or instead be summarized in terms of how UEs communicate, with a network and with each other. For example, from the perspective of a UE of the second type, a method may involve communicating, by the UE with a network device in a wireless communication network, according to a limited-operation configuration for limited communication operations of the UE with the network device (shown by way of example at 922, 1022 in FIGS. 9 and 10); and communicating, by the UE, with the network device according to coordinated operation with another UE (of the first type) for communicating with the network device (shown by way of example at 924, 920 and 1024, 1020 in FIGS. 9 and 1o). The limited communication operations are limited relative to a full-operation configuration of the other UE for communications with the network device.

From the perspective of the other UE (of the first type), a method may involve receiving, from a network device for example, signaling that indicates a full-operation configuration. This is shown by way of example at 912 in FIG. 9. The full-operation configuration is for less limited communication operations of the first type UE with the network device relative to limited communication operations for which a UE of the second type is configured. As in other embodiments, operation of the first type UE is to be coordinated with the second type UE for communicating with the network device. The limited communication operations are limited relative to a full-operation configuration of the other UE for communications with the network device.

Again, the UE (second type) and the other UE (first type) in this example have different roles in coordinated operation, and operate differently. For instance, this example method may involve communicating, by the other UE, with the network device according to the full-operation configuration.

Another method, from the perspective of a UE of the first type, may involve communicating, by the first type UE with a network device in a wireless communication network, according to a full-operation configuration for communication operations of the UE with the network device, as shown by way of example at 920, 1020 in FIGS. 9 and 10; and communicating, by the first type UE, with the network device according to coordinated operation with a second type UE for communicating with the network device, as shown byway of example at 922, 1022 in FIGS. 9 and 10. The full-operation configuration is less limited than a limited-operation configuration of the second type UE.

In the context of such methods, any of various features disclosed herein may be provided. For example, any one or more of the following may be provided, in any of various combinations:
the limited-operation configuration is or includes either or both of: a configuration for uplink transmission and a configuration for downlink reception;
the limited-operation configuration indicates a subset of signals or channels configured for the other UE;
a method may involve exchanging, between the UE and the other UE, communication information due to the limited communication operations of the UE with the network device, as shown by way of example at 924, 1024, to supplement the limited communication operations by enabling the UE to receive communication information from and/or transmit communication information to a network device indirectly, through the other UE;
the signaling is or includes an explicit indication of the limited-operation configuration or an implicit indication of the limited-operation configuration—examples of such indications are provided elsewhere herein and several examples are also provided below;
the signaling is or includes an implicit indication of the limited-operation configuration, and the implicit indication is or includes an indication of an antenna configuration;
the signaling is or includes an implicit indication of the limited-operation configuration, and the implicit indication is or includes an indication that the UE is a secondary UE for coordinated operation with the other UE as a primary UE;
the signaling is or includes either or both of: semi-static signaling and dynamic signaling;
receiving the signaling involves receiving the signaling by the UE from the network device;
receiving the signaling involves receiving the signaling by the UE from the other UE.

Exchanging communication information between UEs may involve exchanging any of various types of communication information. Such communication information may be transmitted from a second type UE to a first type UE and received by the first type UE, and/or be transmitted from a first type UE to a second type UE and received by the second type UE. Examples of communication information are provided elsewhere herein, and communication information exchanged between UEs may include any one or more of: signals or information from major signals or channels monitored/received by a first type UE that a second type UE is not configured to monitor or receive from a network device directly; information corresponding to DCI received in PDCCH and decoded by a first type UE (such as any of: scheduling information for scheduling the second type of UE, TPC command for the second type of UE; a wake-up signal transmitted to a second type UE to wake up the second type of UE by a first type UE after the first type UE receives paging from a gNB or other network device; information collected from a second type UE by a first type UE, for the first type UE to pass that to a network device (such as any of: DL CSI feedback, and UCI for DL transmission including HARQ-ACK feedback and/or SR); TA information transmitted by a first type UE to a second type UE for timing alignment of the second type of UE. These are illustrative and non-limiting examples of communication information that may be exchanged between UEs in some embodiments.

Some embodiments may involve receiving signaling that indicates a configuration. According to another embodiment, a method involves transmitting, to a UE for which operation is to be coordinated with an other UE for communicating with a network device in a wireless communication network, signaling that indicates a limited-operation configuration, and communicating with the UE according to the limited-operation configuration.

A network device, or a UE, may transmit such signaling. In FIG. 9, the gNB is an example of a network device that may transmit such signaling, as shown at 914. FIG. 9 also illustrates at 912 that a network device may transmit, to a first type UE, signaling that indicates a full-operation configuration. As shown by way of example at 1012 in FIG. 10, in some embodiments signaling that indicates a limited-operation configuration may be transmitted by a first type UE (UE #1 in this example) to a second type UE (UE #2 in this example). Although FIG. 10 relates to an example in which the UE that transmits signaling at 1012 also makes the coordinated operations decision at 1010, this is not necessarily always the case. For example, a gNB or other network device could make the coordinated operation decision as shown in FIG. 9, transmit the full-operation configuration and the limited-operation configuration to UE #1, and then UE #1 could relay the limited-operation configuration to UE #1. Therefore, a UE such as a primary UE may transmit a limited-operation configuration to a second type UE without necessarily also itself making a decision as to whether coordinated operation between UEs is to be configured.

Communicating with the second type UE according to the limited-operation configuration may involve UE-network device communications as shown by way of example at 1022. In the context of the present example method, transmitting the signaling involves transmitting the signaling by the network device to the UE, and the communicating involves communicating between the network device and the UE.

In another embodiment, the transmitting involves transmitting the signaling by the other UE (first type) to the UE (second type), and the communicating involves exchanging communication information between the UE and the other UE. This exchanging of communication information, as described herein, is due to the limited communication operations of the UE with the network device, which in turn is due to the limited-operation configuration for the UE. In at least this sense, communicating with the UE by exchanging communication information between the UE and the other UE is a form of communicating with the UE according to the limited-operation configuration.

Any of various features disclosed herein may be provided in methods that involve transmitting signaling. For example, any one or more of the following may be provided, in any of various combinations:
the limited-operation configuration is or includes either or both of: a configuration for uplink transmission and a configuration for downlink reception;
the limited-operation configuration indicates a subset of signals or channels configured for the other UE;
the signaling is or includes an explicit indication of the limited-operation configuration or an implicit indication of the limited-operation configuration—examples of such indications are provided elsewhere herein and several examples are also provided below;
the signaling is or includes an implicit indication of the limited-operation configuration, and the implicit indication is or includes an indication of an antenna configuration;
the signaling is or includes an implicit indication of the limited-operation configuration, and the implicit indication is or includes an indication that the UE is a secondary UE for coordinated operation with the other UE as a primary UE;
the signaling is or includes either or both of: semi-static signaling and dynamic signaling.

These method examples are illustrative and non-limiting embodiments, and other embodiments may include additional or different features disclosed herein.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

An apparatus may include a processor and a non-transitory computer readable storage medium, coupled to the processor, storing programming for execution by the processor. In FIG. 3, for example, the processors 210, 260, 276 may each be or include one or more processors, and each memory 208, 258, 278 is an example of a non-transitory computer readable storage medium, in an ED 110 and a TRP 170, 172. A non-transitory computer readable storage medium need not necessarily be provided only in combination with a processor, and may be provided separately in a computer program product, for example.

As an illustrative example, programming stored in or on a non-transitory computer readable storage medium may include instructions to, or to cause a processor to, receive, by a UE for which operation is to be coordinated with an other UE for communicating with a network device in a wireless communication network, signaling that indicates a limited-operation configuration for limited communication operations of the UE with the network device, wherein the limited communication operations are limited relative to a full-operation configuration of the other UE for communications with the network device; and communicate, by the UE, with the network device according to the limited-operation configuration.

In some embodiments, programming may further include instructions to, or to cause a processor to, exchange, between the UE and the other UE, communication information due to the limited communication operations of the UE with the network device.

Programming may include instructions to, or to cause a processor to, receive the signaling from the network device, or to receive the signaling from the other UE.

In another embodiment, programming may include instructions to, or to cause a processor to, transmit, to a UE for which operation is to be coordinated with an other UE for communicating with a network device in a wireless communication network, signaling that indicates a limited-operation configuration for limited communication operations of the UE with the network device, wherein the limited communication operations are limited relative to a full-operation configuration of the other UE for communications with the network device; and communicate with the UE according to the limited-operation configuration.

The programming may include instructions to, or to cause a processor to, transmit the signaling by the network device to the UE, and to communicate between the network device and the UE.

In another embodiment, the programming includes instructions to, or to cause a processor to, transmit the signaling by the other UE to the UE, and to communicate with the UE by exchanging, between the UE and the other UE, communication information due to the limited communication operations of the UE with the network device.

Embodiments related to apparatus or non-transitory computer readable storage media may include any one or more of the following features, for example, which are also discussed elsewhere herein:
the limited-operation configuration is or includes either or both of: a configuration for uplink transmission and a configuration for downlink reception;
the limited-operation configuration indicates a subset of signals or channels configured for the other UE;
the signaling is or includes an explicit indication of the limited-operation configuration or an implicit indication of the limited-operation configuration;
the signaling is or includes an implicit indication of the limited-operation configuration, and the implicit indication is or includes an indication of an antenna configuration;
the signaling is or includes an implicit indication of the limited-operation configuration, and the implicit indication is or includes an indication that the UE is a secondary UE for coordinated operation with the other UE as a primary UE;
the signaling is or includes either or both of: semi-static signaling and dynamic signaling.

Other features disclosed herein may also or instead be implemented in apparatus embodiments and/or in computer program product embodiments.

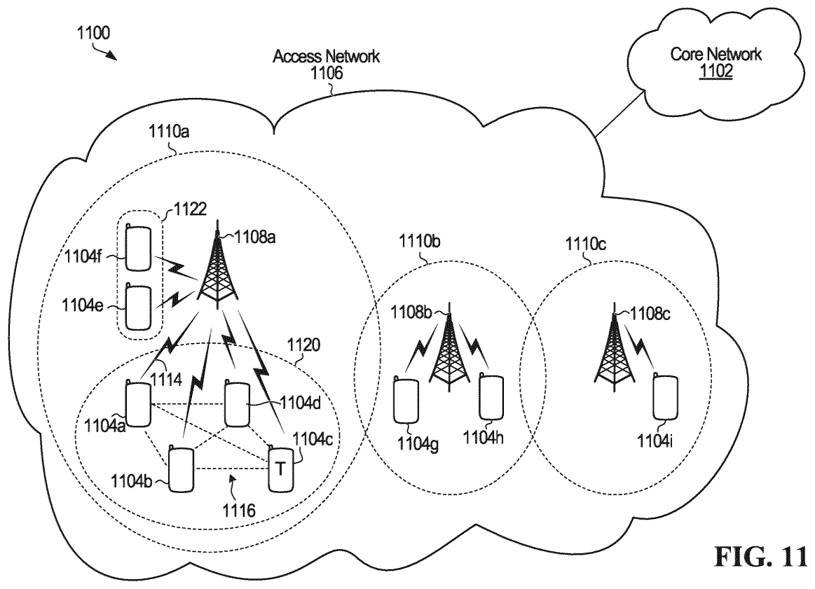

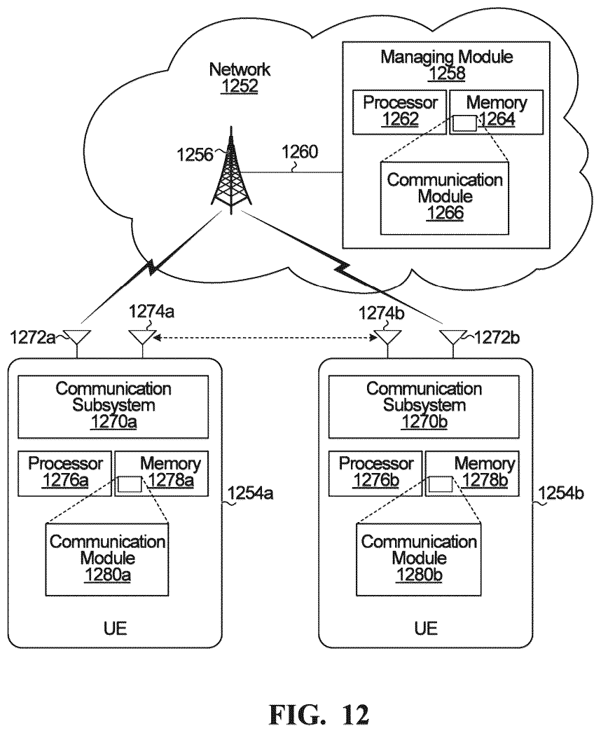

FIGS. 1 to 3 and 5 to 8 provide examples of communication systems and devices in which, or in conjunction with which, embodiments disclosed herein may be implemented. Additional network examples are shown in FIGS. 11 and 12.

FIG. 11 is a block diagram illustrating an example of a telecommunications network 1100 according to one embodiment. The telecommunications network 1100 includes a core network 1102 and a radio access network 1106. The radio access network 1106 serves a plurality of UEs 1104a, 1104b, 1104c, 1104d, 1104e, 1104f, 1104g, 1104h, and 1104i. The access network 1106 is an Evolved Universal Terrestrial Access (E-UTRA) network in some embodiments. Another example of a radio access network 1106 is a cloud access network (C-RAN). The radio access network 1106 includes a plurality of BSs 1108a, 1108b, and 1108c. The BSs 1108a-c each provide a respective wireless coverage area 1110a, 1110b, and 1110c, also referred to as a cell. Each of the BSs 1108a-c could be implemented using a radio transceiver, one or more antennas, and associated processing circuitry, such as antenna radio frequency (RF) circuitry, one or more analog-to-digital converters, one or more digital-to-analog converters, etc.

Although not illustrated, the BSs 1108a-c are each connected to the core network 1102, either directly or through one or more central processing hubs, such as servers. The BSs 1108a-c could serve as a gateway between the wireline and wireless portion of the access network 1106.

Each one of BSs 1108a-c may instead be referred to as a base transceiver station, a radio BS, a network node, a transmit node, a transmit point, a Node B, an eNode B, a remote radio head (RRH), or otherwise, depending upon the implementation.

In operation, the plurality of UEs 1104a-i access the telecommunications network 1100 using the access network 1106 by wirelessly communicating with one or more of the BSs 1108a-c.

UEs 1104a-d are in close proximity to each other. Although the UEs 1104a-d can each wirelessly communicate with the BS 1108a, they can also directly communicate with each other, as represented at 1116. The communications represented at 1116 are direct communications between UEs, such as sidelink communications, that do not go through an access network component, such as a BS. Such communications between UEs are also referred to herein as UE-to-UE communications or inter-UE communications. As shown in FIG. 11, UE-to-UE communications 1116 are directly between the UEs 1104a-d and are not routed through the BS 1108a, or any other part of the access network 1106. Communications 1116 may also be referred to as lateral communications. In embodiments disclosed herein, UE-to-UE communications may use a sidelink channel and a sidelink air interface. On the other hand, a communication between an access network component, such as BS 1108a, and a UE, as in communication 1114, is called an access communication. An access communication occurs over an access channel, which can be an uplink or downlink channel, and an access communication uses a radio access communication interface, such as a cellular radio access air interface. Access and inter-UE air interfaces may use different transmission formats, such as different waveforms, different multiple access schemes, or different radio access technologies. Some examples of radio access technologies that could be used by an access air interface or an inter-UE air interface are: Long Term Evolution (LTE), LTE License Assisted Access (LTE-LAA), and WiFi.

By using the sidelink (or other inter-UE) communications 1116, the UEs 1104a-d may be able to assist with wireless communications between the UEs 1104a-d and the BS 1108a. As one example, if UE 1104c fails to correctly decode a packet received from the BS 1108a but UE 1104d is able to receive and correctly decode the packet from the BS 1108a, then UE 1104d could directly transmit the decoded packet to UE 1104c using UE-to-UE communications 1116. As another example, if UE 1104c moves out of wireless coverage area 1111c, such that UE 1104c can no longer wirelessly communicate with the BS 1108a, then UE 1104b could forward messages between the UE 1104c and the BS 1108a. As another example, UE 1104a and UE 1104c could both receive a signal transmitted from the BS 1108a that carries a packet meant for UE 1104c. UE 1104a may then transmit to UE 1104c, via UE-to-UE communications 1116, the signal as received by UE 1104a. UE 1104c may then use the information received from UE 1104a to help decode the packet from the BS 1108a. In these examples, UE operation is coordinated to assist one or more of the UEs 1104a, 1104b, and 1104d.

The UEs 1104a-d form a UE group 1120 in some embodiments. It should be noted, however, that features as disclosed herein are not dependent upon UE groups being explicitly formed in advance.

In UE group 1120 and a scenario in which the UE 1104c is to be assisted, the other UEs 1104a, 1104b, and 1104d form a candidate set for assisting the UE 1104c. If UEs 1104a and 1104b assist the UE 1104c, then the UEs 1104a and 1104b form what may be called a coordination active set, or in UC embodiments a cooperation active set. As UEs 1104a-d move around, some may leave the UE group 1120. UE movement may also or instead result in other UEs joining the UE group 1120. Therefore, the candidate set may change over time. For example, the candidate set may change semi-statically. The UE group 1120 may also be terminated by the network 1106, for example, if the network determines that there is no longer a need or opportunity for the UE group 1120 to provide assistance in wireless communication between the BS 1108a and members of the UE group 1120.

There may be more than one UE group. For example, UEs 1104e and 1104f in FIG. 11 form another UE group 1122.

FIG. 12 is a block diagram illustrating an example of a network 1252 serving two UEs 1254a and 1254b, according to one embodiment. The network 1252 may be the access network 1106 from FIG. 11, and the two UEs 1254a and 1254b may be two of the four UEs 1104a-d in FIG. 11, or the UEs 1254a and 1254b may be UEs 1140e and 1104f in FIG. 11. However, more generally this need not be the case, which is why different reference numerals are used in FIG. 12.

The network 1252 includes a BS 1256 and a managing module 1258. The managing module 1258 instructs the BS 1256 to perform actions. The managing module 1258 is illustrated as physically separate from the BS 1256 and coupled to the BS 1256 via a communication link 1260. For example, the managing module 1258 may be part of a server in the network 1252. Alternatively, the managing module 1258 may be part of the BS 1256.

The managing module 1258 includes a processor 1262, a memory 1264, and a communication module 1266. The communication module 1266 is implemented by the processor 1262 when the processor 1262 accesses and executes a series of instructions stored in the memory 1264, the instructions defining the actions of the communication module 1266. When the instructions are executed, the communication module 1266 causes the BS 1256 to perform the actions described herein so that the network 1252 can, in some embodiments, establish, instruct, or control coordinated operation of UEs. Alternatively, the communication module 1266 may be implemented using dedicated circuitry, such as an application specific integrated circuit (ASIC) or a programmed field programmable gate array (FPGA).

The UE 1254a includes a communication subsystem 1270a, two antennas 1272a and 1274a, a processor 1276a, and a memory 1278a. The UE 1254a also includes a communication module 1280a. The communication module 1280a is implemented by the processor 1276a when the processor 1276a accesses and executes a series of instructions stored in the memory 1278a, the instructions defining the actions of the communication module 1280a. When the instructions are executed, the communication module 1280a causes the UE 1254a to perform actions described herein in relation to coordinated operation of UEs. Alternatively, the module 1280a may be implemented by dedicated circuitry, such as an ASIC or an FPGA.

The communication subsystem 1270a includes processing circuitry, transmit circuitry, and receive circuitry for sending messages from and receiving messages at the UE 1254a. Although one communication subsystem 1270a is illustrated, the communication subsystem 1270a may be multiple communication subsystems. Antenna 1272a transmits wireless communication signals to, and receives wireless communications signals from, the BS 1256. Antenna 1274a transmits inter-UE communication signals to, and receives inter-UE communication signals from, other UEs, including UE 1254b. In some implementations there may not be two separate antennas 1272a and 1274a. A single antenna may be used. Alternatively, there may be several antennas, but not separated into antennas dedicated only to inter-UE communication and antennas dedicated only to communicating with the BS 1256.

Inter-UE communications could be over Wi-Fi, in which case the antenna 1274a may be a Wi-Fi antenna. Alternatively, the inter-UE communications could be over Bluetooth™, in which case the antenna 1274a may be a Bluetooth™ antenna. Inter-UE communications could also or instead be over licensed or unlicensed spectrum.

The UE 1254b includes the same components described above with respect to the UE 1254a. That is, UE 1254b includes communication subsystem 1270b, antennas 1272b and 1274b, processor 1276b, memory 1278b, and communication module 1980b.

FIGS. 11 and 12 illustrate systems in which embodiments could be implemented. In some embodiments, a UE includes a processor, such as 1976a, 1976b in FIG. 12, and a non-transitory computer readable storage medium, such as 1978a, 1978b in FIG. 12, storing programming comprising instructions for execution by the processor. A non-transitory computer readable storage medium could also or instead be provided separately, as a computer program product. Examples are provided elsewhere herein.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

Features disclosed herein in the context of method embodiments, for example, may also or instead be implemented in apparatus or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Although aspects of the present invention have been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although embodiments and potential advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer readable or processor readable storage medium or media for storage of information, such as computer readable or processor readable instructions, data structures, program modules, and/or other data. A non-exhaustive list of examples of non-transitory computer readable or processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and nonremovable media implemented in any method or technology, random-access memory (RAM), read-only memory (ROM), electrically erasable programmable read-only memory (EEPROM), flash memory or other memory technology. Any such non-transitory computer readable or processor readable storage media may be part of a device or accessible or connectable thereto. Any application or module herein described may be implemented using instructions that are readable and executable by a computer or processor may be stored or otherwise held by such non-transitory computer readable or processor readable storage media.

1. A method performed by an apparatus, comprising:
receiving signaling that indicates a limited-operation configuration for limited communication operations of the apparatus with a network device in a wireless communication network, wherein operations of the apparatus are to be coordinated with an other terminal for communicating with the network device, and wherein the limited communication operations are limited relative to a full-operation configuration of the other terminal for communications with the network device; and
communicating with the network device according to the limited-operation configuration.

2. The method of claim 1, wherein the limited-operation configuration comprises at least one of: a configuration for uplink transmission or a configuration for downlink reception.

3. The method of claim 1, wherein the limited-operation configuration indicates a subset of signals or channels configured for the other terminal.

4. The method of claim 1, further comprising:
exchanging, between the apparatus and the other terminal, communication information due to the limited communication operations of the apparatus with the network device.

5. The method of claim 1, wherein the signaling comprises an explicit indication of the limited-operation configuration or an implicit indication of the limited-operation configuration.

6. The method of claim 1, wherein the signaling comprises an implicit indication of the limited-operation configuration, the implicit indication indicating an antenna configuration.

7. The method of claim 1, wherein the signaling comprises an implicit indication of the limited-operation configuration, the implicit indication indicating that the apparatus is a secondary terminal for coordinated operation with the other terminal as a primary terminal.

8. A method performed by an apparatus, comprising:
transmitting, to a terminal for which operations are to be coordinated with an other terminal for communicating with a network device in a wireless communication network, signaling that indicates a limited-operation configuration for limited communication operations of the terminal with the network device, and wherein the limited communication operations are limited relative to a full-operation configuration of the other terminal for communications with the network device; and
communicating with the terminal according to the limited-operation configuration,
wherein the apparatus is or is part of the network device.

9. The method of claim 8, wherein the limited-operation configuration comprises at least one of: a configuration for uplink transmission or a configuration for downlink reception.

10. The method of claim 8, wherein the limited-operation configuration indicates a subset of signals or channels configured for the other terminal.

11. The method of claim 8, wherein the signaling comprises an explicit indication of the limited-operation configuration or an implicit indication of the limited-operation configuration.

12. The method of claim 8, wherein the signaling comprises an implicit indication of the limited-operation configuration, the implicit indication indicating of an antenna configuration.

13. The method of claim 8, wherein the signaling comprises an implicit indication of the limited-operation configuration, the implicit indication indicating that the terminal is a secondary terminal for coordinated operation with the other terminal as a primary terminal.

14. The method of claim 8, wherein the signaling comprises at least one of: semi-static signaling or dynamic signaling.

15. An apparatus comprising:
at least one processor; and
a non-transitory computer readable storage medium, coupled to the at least one processor, storing programming for execution by the at least one processor, the programming including instructions causing the apparatus to:
receive signaling that indicates a limited-operation configuration for limited communication operations of the apparatus with a network device in a wireless communication network, wherein operations of the apparatus are to be coordinated with an other terminal for communicating with the network device, and wherein the limited communication operations are limited relative to a full-operation configuration of the other terminal for communications with the network device; and
communicate, with the network device according to the limited-operation configuration.

16. The apparatus of claim 15, wherein the limited-operation configuration comprises at least one of: a configuration for uplink transmission or a configuration for downlink reception.

17. The apparatus of claim 15, wherein the limited-operation configuration indicates a subset of signals or channels configured for the other terminal.

18. The apparatus of claim 15, the programming further including instructions causing the apparatus to:
exchange, between the apparatus and the other terminal, communication information due to the limited communication operations of the apparatus with the network device.

19. The apparatus of claim 15, wherein the signaling comprises an explicit indication of the limited-operation configuration or an implicit indication of the limited-operation configuration.

20. The apparatus of claim 15, wherein the signaling comprises an implicit indication of the limited-operation configuration, the implicit indication indicating an antenna configuration.
